(19) United States
(12) Patent Application Publication
(10) Pub. No.: US 2010/0278983 A1
(43) Pub. Date: Nov. 4, 2010

(54) COMPOSITION OF MONASCUS FERMENTED PRODUCT WITH A FUNCTION THAT REDUCES BODY FATNESS FORMATION AND THE METHOD FOR MANUFACTURING THE SAME

(75) Inventors: Tzu-Ming PAN, Sijhih City (TW); Wen-Pei CHEN, Sinjhuang City (TW)

Correspondence Address: ROGER H. CHU, 19499 ERIC DRIVE, SARATOGA, CA, 95070, US

(73) Assignee: SUNWAY BIOTECH CO., LTD., Taipei City (TW)

(21) Appl. No.: 12/690,392

(22) Filed: Jan. 20, 2010

(30) Foreign Application Priority Data
Apr. 29, 2009 (TW) 098114285

(51) Int. Cl. A23L 1/28

(52) U.S. Cl. 426/327

(57) ABSTRACT

The present invention discloses a composition of Monascus fermented product with a function that reduces body fatness formation and the method for manufacturing the same, the substrates for manufacturing Monascus fermented product are rice and dioscorea, and the manufacturing method is to use water and ethanol to be solutions in order to manufacture the Monascus fermented product, which is proven to have the effect of reducing body fatness formation by in vitro experiments and animal experiments.

### CROSS-REFERENCE TO RELATED APPLICATION

This application claims foreign priority from a Taiwan Patent Application, Ser. No. 098114285, filed on Apr. 29, 2009.

### BACKGROUND OF THE INVENTION

1. Field of the Invention

The present invention relates to a composition of Monascus fermented product with a function that reduces body fatness formation and the method for manufacturing the same, and more particularly, the substrates for manufacturing the composition of Monascus fermented product are red mold rice and red mold dioscorea, and the composition is able to be extracted by water or ethanol.

2. Description of the Prior Art

Following the economy development and the changes of the eating habits, obesity has become a murder of human's health. Due to the kinds of diseases derived from obesity are countless, the subject matter of reducing the incidence of obesity is nowadays in the limelight.

Monascus is the traditional fermentative bacteria strain in China, and the exceptional effects of Monascus have already recorded on the ancient books. In recent years, owing to the raise of health concepts, compatriots identify the importance of the preventive medical gradually and expect the replacement of synthetic medicines by nature food. The trend of taking health food makes the research of Monascus more thorough. The reported physiological effects of Monascus include lowering blood lipid, lowering blood pressure, lowering blood sugar, and anti-cancer effects. Lately, fermented products of red mold rice have discovered to inhibit the differentiation of fat cells and decrease the accumulation of fats. Therefore, Monascus should have potency to be applied in the improvement of obesity.

Monacolin K (a lovastatin) is a blood-lipid lowering material produced by Monascus, and according to some researching reports, this kind of statins can regulate the differentiation of fat cells. In addition to monacolin K, recently, there are some references indicating that the water extraction of Monascus can also inhibit the differentiation of 3T3-L1 preadipocyte.

In view of this, if a composition of Monascus fermented product with a function that reduces body fatness formation and the method for manufacturing the same are developed, obesity will be overcome easily in the future.

### SUMMARY OF THE INVENTION

In view of the above shortcomings of the prior art, the inventor of the present invention resorted to past experience, imagination, and creativity, performed experiments and researches repeatedly, and eventually devised the present invention—a composition of Monascus fermented product with a function that reduces body fatness formation and the method for manufacturing the same.

The first objective of the present invention is to provide a composition of Monascus fermented product with a function that reduces body fatness formation to inhibit the differentiation of fat cell, wherein the present invention use red mold rice and red mold dioscorea as raw materials for the composition of Monascus fermented product, and the effects of the composition of Monascus fermented product are analyzed by in vitro cellular experiments and animal experiments.
1. The second objective of the present invention is to provide a method for manufacturing the composition of Monascus fermented product with a function that reduces body fatness formation, owing to the constituents and the effects of the composition of Monascus fermented product are very diverse under different extraction methods and conditions, the present invention provide the optimum extraction method and condition to obtain the best composition of Monascus fermented product.

Consequently, the present invention provide a method for manufacturing the composition of Monascus fermented product with a function that reduces body fatness formation comprising the steps of: (1) drying a Monascus substrate; (2) grinding the dried Monascus substrate to powder; (3) extracting the powdered Monascus substrate with water under a first specific temperature for a specific time period; (4) filtering the extracted product through a filtration membrane with a specific pore diameter; (5) freeze-drying the filtrate; and (6) dissolving the dried product to a specific concentration with a specific solvent and preserving the solution under a second specific temperature.

The present invention further provide another method for manufacturing the composition of Monascus fermented product with a function that reduces body fatness formation comprising the steps of: (1) drying a Monascus substrate; (2) grinding the dried Monascus substrate to powder; (3) extracting the powdered Monascus substrate with water under a first specific temperature for a first specific time period; (4) filtering the extracted product through a filtration membrane with a first specific pore diameter; (5) dissolving the non-filtrate with a first specific concentration of ethanol and extracting the solution under a second specific temperature for a second specific time period; (6) filtering the extracted product through a filtration membrane with a second specific pore diameter; (7) placing the filtrate on a ventilated space to evaporate the ethanol naturally; and (8) dissolving the dried product to a second specific concentration with ethanol again and preserving the solution under a third specific temperature.

### BRIEF DESCRIPTION OF THE DRAWINGS

FIG. 1 is a flowchart of a first preferred method for manufacturing a composition of Monascus fermented product with a function that reduces body fatness formation according to the present invention;

FIG. 2 is a flowchart of a second preferred method for manufacturing a composition of Monascus fermented product with a function that reduces body fatness formation according to the present invention;

FIGS. 3A and 3B are flowcharts of a third preferred method for manufacturing a composition of Monascus fermented product with a function that reduces body fatness formation according to the present invention;

FIGS. 4A and 4B are flowcharts of a fourth preferred method for manufacturing a composition of Monascus fermented product with a function that reduces body fatness formation according to the present invention;

FIG. 5A is a graph of water extracts of red mold rice affecting the proliferation of 3T3-L1 preadipocyte;

FIG. 5B is a graph of ethanol extracts of red mold rice affecting the proliferation of 3T3-L1 preadipocyte;

FIG. 5C is a graph of ethanol extracts of red mold dioscorea affecting the proliferation of 3T3-L1 preadipocyte;

FIG. 5D is a graph of Monacolin K affecting the proliferation of 3T3-L1 preadipocyte;

FIG. 5E is a graph of Monascin affecting the proliferation of 3T3-L1 preadipocyte;

FIG. 5F is a graph of Ankaflavin affecting the proliferation of 3T3-L1 preadipocyte;

FIG. 6A is a graph of water extracts of red mold rice affecting the differentiation of 3T3-L1 preadipocyte;

FIG. 6B is a graph of water extracts of red mold dioscorea affecting the differentiation of 3T3-L1 preadipocyte;

FIG. 6C is a graph of ethanol extracts of red mold rice affecting the differentiation of 3T3-L1 preadipocyte;

FIG. 6D is a graph of ethanol extracts of red mold dioscorea affecting the differentiation of 3T3-L1 preadipocyte;

FIG. 6E is a graph of Ankaflavin affecting the differentiation of 3T3-L1 preadipocyte;

FIG. 6F is a graph of Monascin affecting the differentiation of 3T3-L1 preadipocyte;

FIG. 7A is a graph of Monascus fermented products affecting lipolysis activity in perirenal adipose tissues of male Wister rats fed with high-fat diet; and

FIG. 7B is a graph of Monascus fermented products affecting lipolysis activity in epididymal adipose tissues of male Wister rats fed with high-fat diet.

### DETAILED DESCRIPTION OF THE PREFERRED EMBODIMENTS

To achieve the foregoing objectives and effects, the inventors try out all kind of manufacturing methods by using red mold rice and red mold dioscorea as substrates and improve and amend the conditions of manufacturing methods, thus achieving the composition of Monascus fermented product with a function that reduces body fatness formation and the method for manufacturing the same of the present invention.

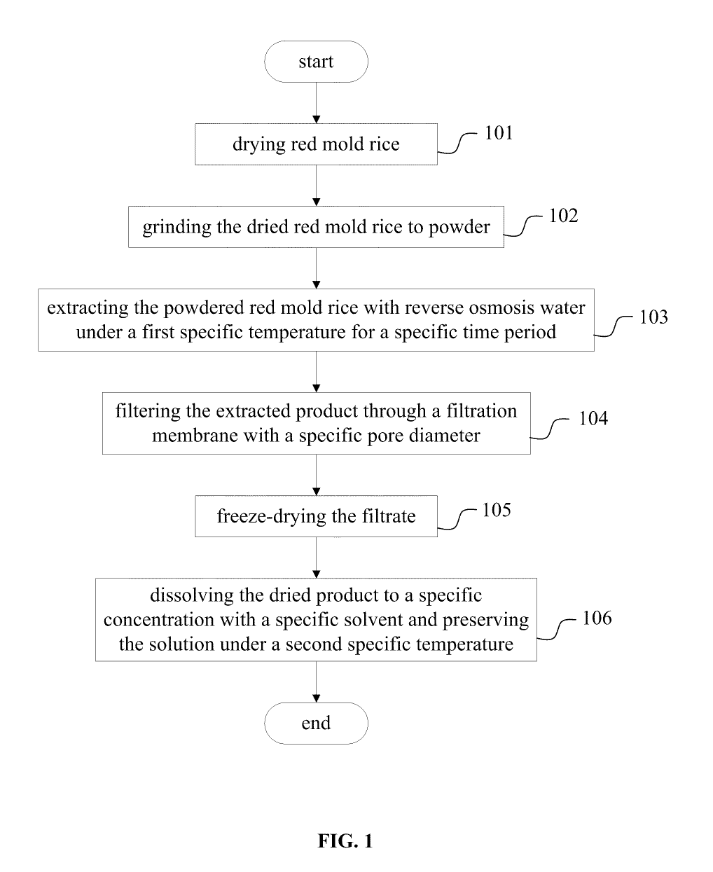

First of all, referring to FIG. 1, which is shown a flowchart of a first preferred method for manufacturing a composition of Monascus fermented product with a function that reduces body fatness formation according to the present invention. The method comprises the following step (101) of drying red mold rice; step (102) of grinding the dried red mold rice to powder; step (103) of extracting the powdered red mold rice with reverse osmosis water under a first specific temperature for a specific time period, wherein the reverse osmosis water is able to be replaced by normal water, the first specific temperature is 25˜65° C., and the specific time period is 24 hours; step (104) of filtering the extracted product through a filtration membrane with a specific pore diameter, wherein the specific pore diameter is 0.22˜0.45 μm; step (105) of freeze-drying the filtrate; and step (106) of dissolving the dried product to a specific concentration with a specific solvent and preserving the solution under a second specific temperature so as to accomplish the method, wherein the specific solvent is phosphate buffer saline (PBS), the specific concentration is 50˜200 μg/mL, and the second specific temperature is −20˜7° C.

The above-mentioned red mold rice in first preferred method comprises monascin and ankaflavin as active ingredients, wherein 1 g of the red mold rice has to contain 1˜30 mg of the monascin and 0.5˜25 mg of the ankaflavin. The red mold rice further comprises Monacolin K as an active ingredient, and 1 g of the red mold rice has to contain 2˜15 mg of the Monacolin K.

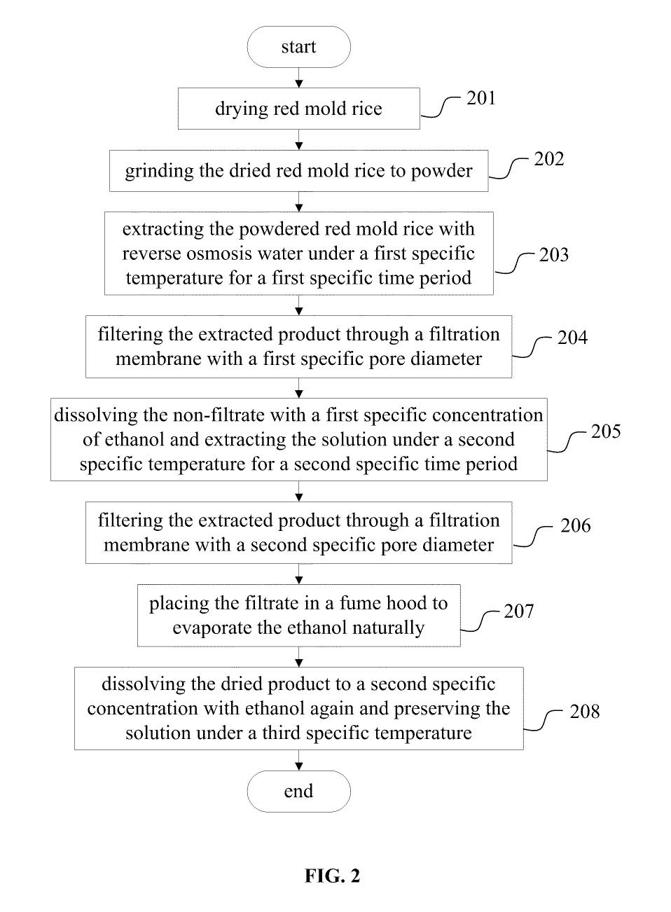

Referring to FIG. 2, which is shown a flowchart of a second preferred method for manufacturing a composition of Monascus fermented product with a function that reduces body fatness formation according to the present invention. The method comprises the following step (201) of drying red mold rice; step (202) of grinding the dried red mold rice to powder; step (203) of extracting the powdered red mold rice with reverse osmosis water under a first specific temperature for a first specific time period, wherein the reverse osmosis water is able to be replaced by normal water, the first specific temperature is 25˜65° C., and the first specific time period is 24 hours; step (204) of filtering the extracted product through a filtration membrane with a first specific pore diameter, wherein the first specific pore diameter is 0.22˜0.45 μm; step (205) of dissolving the non-filtrate with a first specific concentration of ethanol and extracting the solution under a second specific temperature for a second specific time period, wherein the first specific concentration is 50%˜95%, the second specific temperature is 25˜65° C., and the second specific time period is 24 hours; step (206) of filtering the extracted product through a filtration membrane with a second specific pore diameter, wherein the second specific pore diameter is 0.22˜0.45 μm; step (207) of placing the filtrate in a fume hood to evaporate the ethanol naturally, wherein the filtrate can also be placed in a ventilated space; and step (208) of dissolving the dried product to a second specific concentration with ethanol again and preserving the solution under a third specific temperature so as to accomplish the method, wherein the second specific concentration is 50˜200 μg/mL, and the third specific temperature is −20˜7° C.

The above-mentioned red mold rice in second preferred method comprises monascin and ankaflavin as active ingredients, wherein 1 g of the red mold rice has to contain 1˜30 mg of the monascin and 0.5˜25 mg of the ankaflavin. The red mold rice further comprises Monacolin K as an active ingredient, and 1 g of the red mold rice has to contain 2˜15 mg of the Monacolin K.

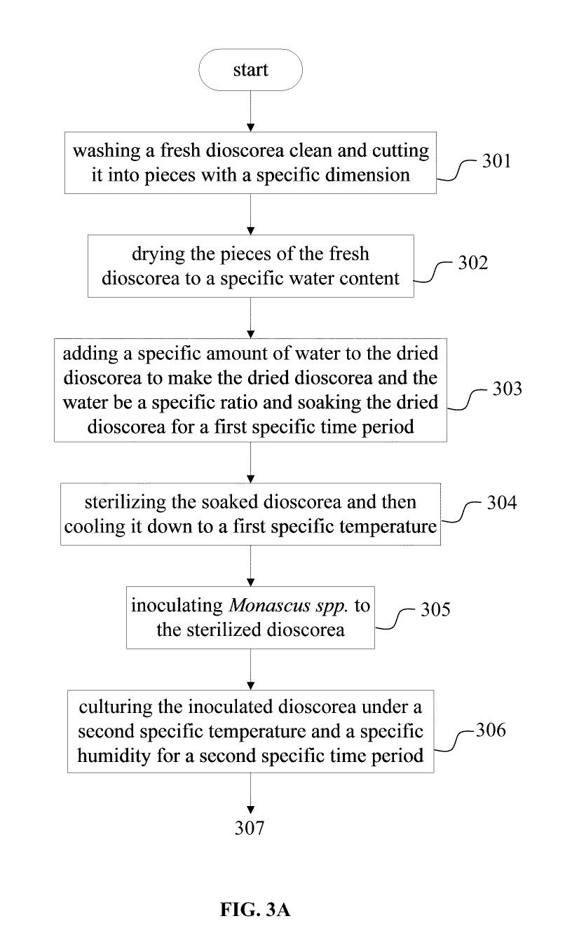

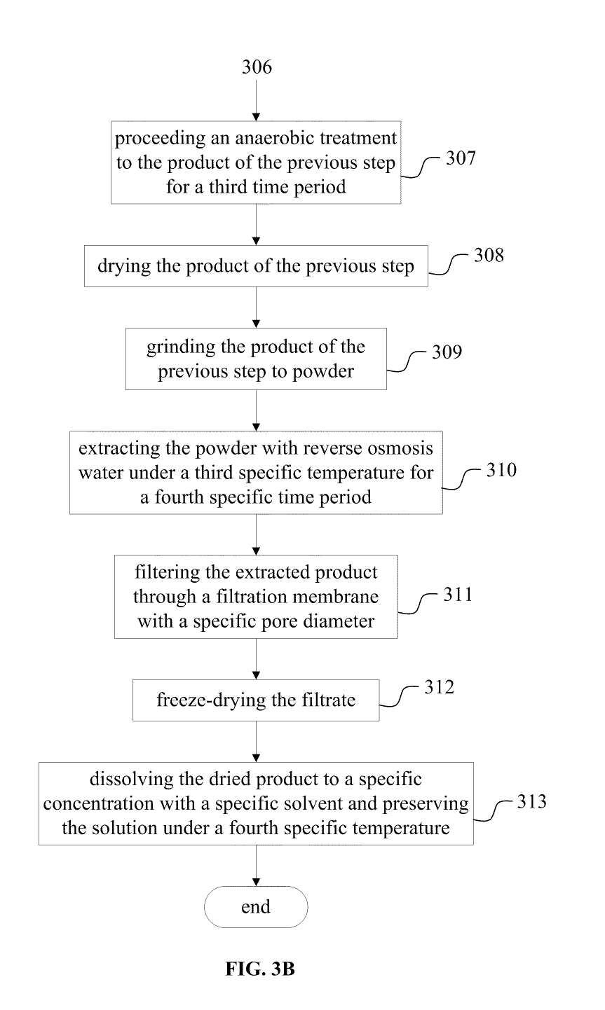

Referring to FIG. 3, which is shown a flowchart of a third preferred method for manufacturing a composition of Monascus fermented product with a function that reduces body fatness formation according to the present invention. The method comprises the following step (301) of washing a fresh dioscorea clean and cutting it into pieces with a specific dimension, wherein the specific dimension is 2˜20 mm; step (302) of drying the pieces of the fresh dioscorea to a specific water content, wherein the specific water content is below 15%; step (303) of adding a specific amount of water to the dried dioscorea to make the dried dioscorea and the water be a specific ratio and soaking the dried dioscorea for a first specific time period, wherein the specific ratio is 1:0.5%˜1:1.5%, and the first specific time period is 0˜60 minutes; step (304) of sterilizing the soaked dioscorea and then cooling it down to a first specific temperature, wherein the method of the sterilization is high temperature sterilization under 121° C. for 10˜60 minutes, and the first specific temperature is room temperature; step (305) of inoculating Monascus spp. to the sterilized dioscorea; step (306) of culturing the inoculated dioscorea under a second specific temperature and a specific humidity for a second specific time period, wherein the second specific temperature is 25˜37° C., the specific humidity is 50˜80%, and the second specific time period is 8˜20 days; step (307) of proceeding an anaerobic treatment to the product of the previous step for a third time period, wherein the third time period is 0˜3 days; step (308) of drying the product of the previous step; step (309) of grinding the product of the previous step to powder; step (310) of extracting the powder with reverse osmosis water under a third specific temperature for a fourth specific time period, wherein the third specific temperature is 25˜65° C., and the fourth specific time period is 24 hours; step (311) of filtering the extracted product through a filtration membrane with a specific pore diameter, wherein the specific pore diameter is 0.22˜0.45 μm; step (312) of freeze-drying the filtrate; and step (313) of dissolving the dried product to a specific concentration with a specific solvent and preserving the solution under a fourth specific temperature so as to accomplish the method, wherein the specific solvent is phosphate buffer saline (PBS), the specific concentration is 50˜200 μg/mL, and the fourth specific temperature is −18˜7° C.

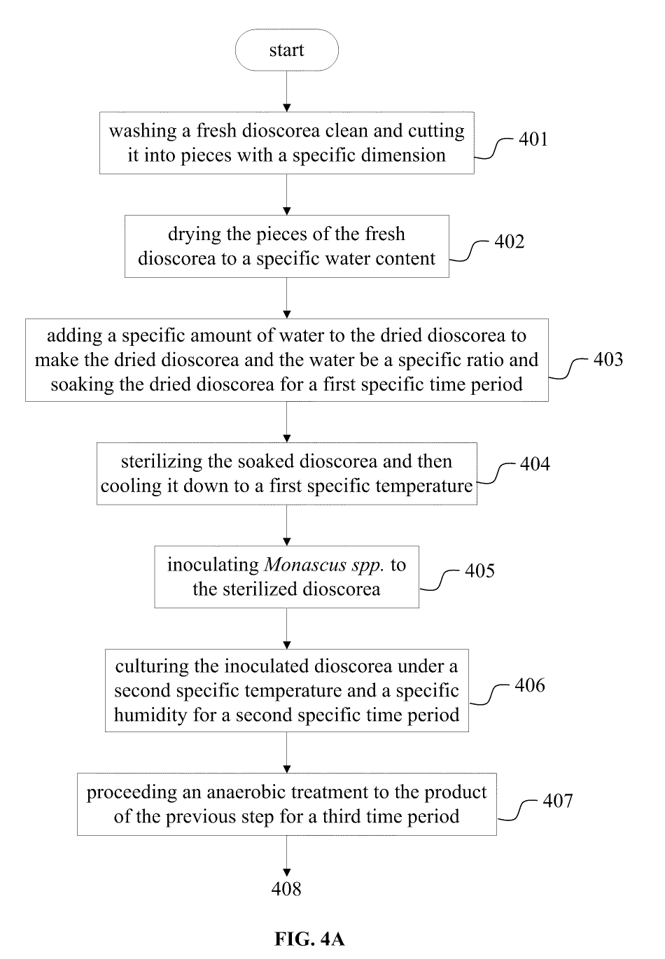

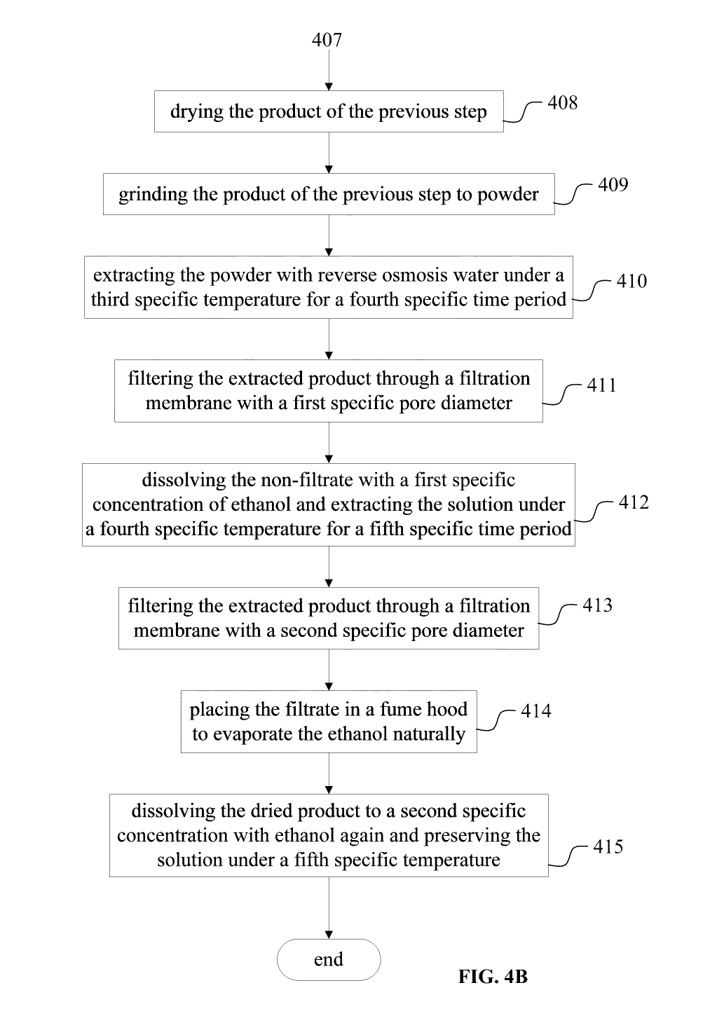

Referring to FIG. 4, which is shown a flowchart of a fourth preferred method for manufacturing a composition of Monascus fermented product with a function that reduces body fatness formation according to the present invention. The method comprises the following step (401) of washing a fresh dioscorea clean and cutting it into pieces with a specific dimension, wherein the specific dimension is 2˜20 mm; step (402) of drying the pieces of the fresh dioscorea to a specific water content, wherein the specific water content is below 15%; step (403) of adding a specific amount of water to the dried dioscorea to make the dried dioscorea and the water be a specific ratio and soaking the dried dioscorea for a first specific time period, wherein the specific ratio is 1:0.5%˜1:1.5%, and the first specific time period is 0˜60 minutes; step (404) of sterilizing the soaked dioscorea and then cooling it down to a first specific temperature, wherein the method of the sterilization is high temperature sterilization under 121° C. for 10˜60 minutes, and the first specific temperature is room temperature; step (405) of inoculating Monascus spp. to the sterilized dioscorea; step (406) of culturing the inoculated dioscorea under a second specific temperature and a specific humidity for a second specific time period, wherein the second specific temperature is 25˜37° C., the specific humidity is 50˜80%, and the second specific time period is 8˜20 days; step (407) of proceeding an anaerobic treatment to the product of the previous step for a third time period so as to produce a red mold dioscorea, wherein the third time period is 0˜3 days; step (408) of drying the product of the previous step; step (409) of grinding the product of the previous step to powder; step (410) of extracting the powder with reverse osmosis water under a third specific temperature for a fourth specific time period, wherein the reverse osmosis water is able to be replaced by normal water, the third specific temperature is 25˜65° C., and the fourth specific time period is 24 hours; step (411) of filtering the extracted product through a filtration membrane with a first specific pore diameter, wherein the first specific pore diameter is 0.22˜0.45 μm; step (412) of dissolving the non-filtrate with a first specific concentration of ethanol and extracting the solution under a fourth specific temperature for a fifth specific time period, wherein the first specific concentration is 50%˜95%, the fourth specific temperature is 25˜65° C., and the fifth specific time period is 24 hours; step (413) of filtering the extracted product through a filtration membrane with a second specific pore diameter, wherein the second specific pore diameter is 0.22˜0.45 μm; step (414) of placing the filtrate in a fume hood to evaporate the ethanol naturally, wherein the filtrate can also be placed in a ventilated space; and step (415) of dissolving the dried product to a second specific concentration with ethanol again and preserving the solution under a fifth specific temperature so as to accomplish the method, wherein the second specific concentration is 50˜200 μg/mL, and the fifth specific temperature is −18˜7° C.

In order to estimate the effects of Monascus fermented product on the decrease in body fat mass development and body weight-lowering, the present invention carried out in vitro cellular experiments and in vivo experiments. 3T3-L1 preadipocyte is used as the experimental material in the in vitro cellular experiments to probe into the effects of Monascus fermented product on proliferation and differentiation in preadipocyte. Male Wister rates are used as the experimental animals in the in vivo experiments and fed with high-fat diet and Monascus fermented products at the same time, then determine the effects of the decrease in body fat mass development by many evaluation indicators after 8 weeks of breeding.

[In Vitro Cellular Experiments]

### 1. Determining the Proliferation Rate of 3T3-L1 Preadipocyte

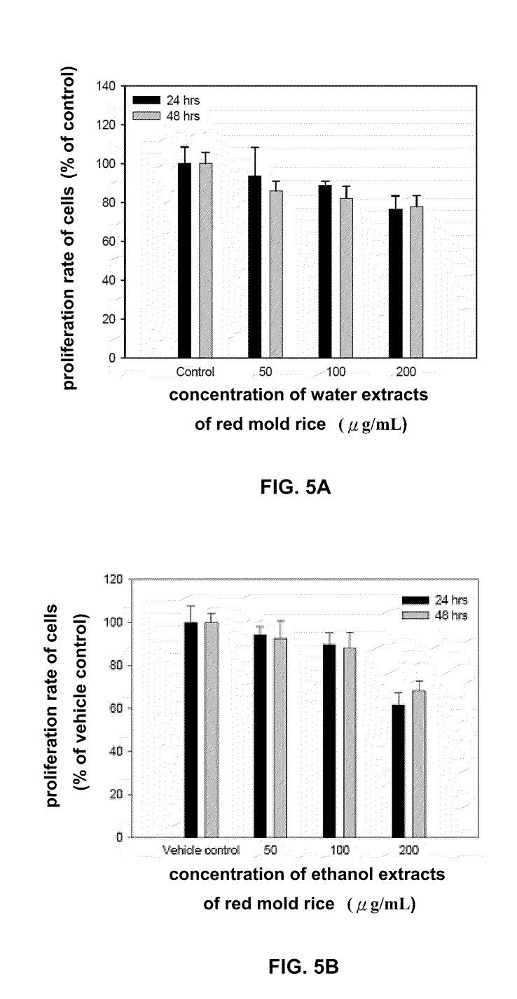

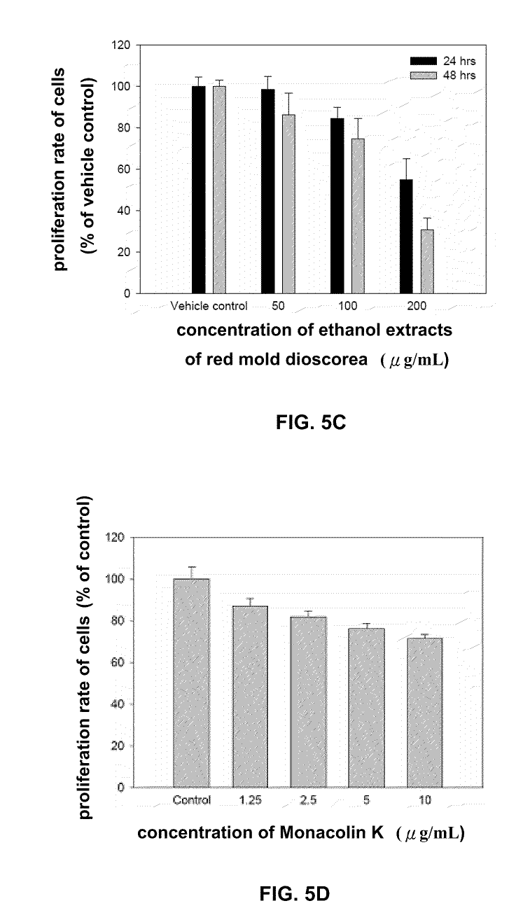

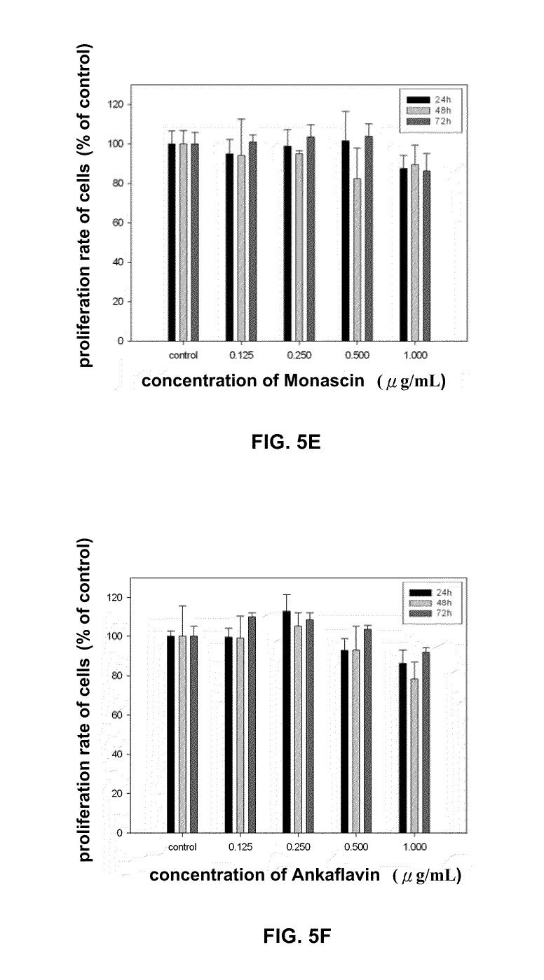

Referring to FIG. 5A, after treating 3T3-L1 preadipocyte with high dosage (200 μg/mL) of water extracts of red mold rice for 24 hours, the proliferation rate of 3T3-L1 preadipocyte is decreased by 23.5% compared to control. After treating 3T3-L1 preadipocyte with each dosage groups (50, 100 and 200 μg/mL) for 48 hours, the proliferation rate of 3T3-L1 preadipocyte is decreased significantly by 14.2%, 17.8% and 22.2% respectively.

Referring to FIG. 5B, ethanol extracts of red mold rice with dosages up to 100 and 200 μg/mL have effects to inhibit the proliferation of 3T3-L1 preadipocyte. The inhibition rates are 10.4% and 38.4% respectively after treating the 3T3-L1 preadipocyte for 24 hours; the inhibition rates are 12.2% and 31.8% respectively after treating the 3T3-L1 preadipocyte for 48 hours.

Referring to FIG. 5C, after treating 3T3-L1 preadipocyte with 100 and 200 μg/mL of ethanol extracts of red mold dioscorea for 24 hours, the proliferation rate of 3T3-L1 preadipocyte is decreased by 15.7% and 45.1% respectively. After treating 3T3-L1 preadipocyte with each dosage groups (50, 100 and 200 μg/mL) for 48 hours, the proliferation rate of 3T3-L1 preadipocyte is decreased significantly by 13.8%, 25.4% and 69.1% respectively.

Referring to FIG. 5D, after treating 3T3-L1 preadipocyte with 1.25, 2.5, 5, and 10 μg/mL of Monacolin K for 24 hours, the proliferation rate of 3T3-L1 preadipocyte is decreased significantly by 13.0%, 18.2%, 23.9%, and 28.6% respectively.

In these examinations, it is proven that the water extracts of red mold rice, the ethanol extracts of red mold rice, the ethanol extracts of red mold dioscorea, and Monacolin K can inhibit the proliferation of 3T3-L1 preadipocyte.

The present invention further investigate the effects of monascin and ankaflavin on the proliferation of 3T3-L1 preadipocyte. Referring to FIG. 5E, the effects on 3T3-L1 preadipocyte by treating with each concentration groups of monascin for 24 and 48 hours are insignificant; after treating 3T3-L1 preadipocyte with 1 mg/mL of monascin for 72 hours, the inhibition rate is significant and up to 8.0%. Referring to FIG. 5F, after treating 3T3-L1 preadipocyte with 1 mg/mL of ankaflavin for 24˜72 hours, there are significant effects on the inhibition to the proliferation of 3T3-L1 preadipocyte. This section proves that monascin and ankaflavin should be the active ingredients in Monascus to decrease body fat formation.

### 2. Determining the Differentiation Rate of 3T3-L1 Preadipocyte (Determining the Content of Triglyceride, TG)

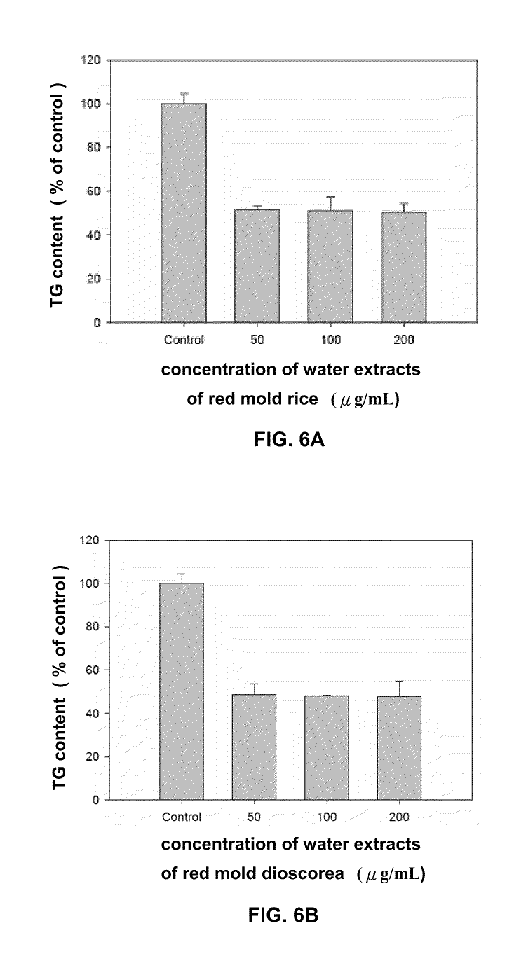

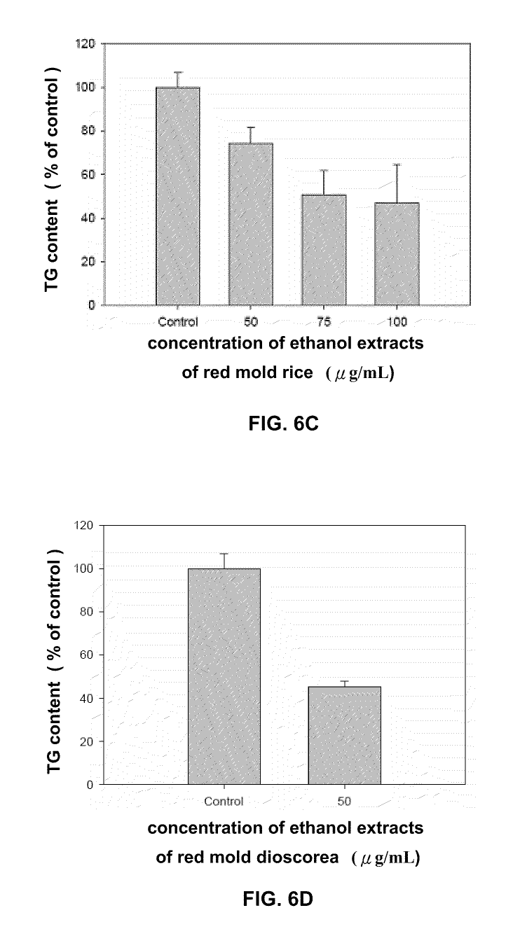

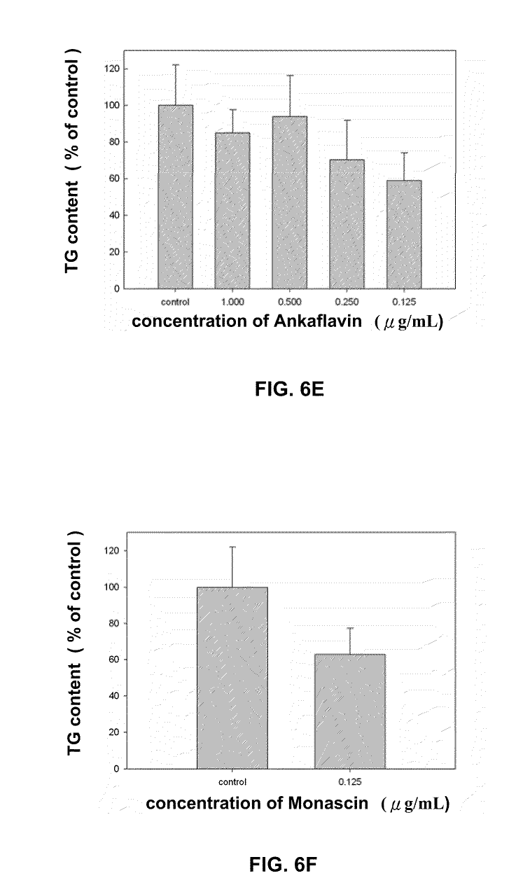

In this research, 50, 100 and 200 μg/mL of water extracts of red mold rice and red mold dioscorea are added to 3T3-L1 preadipocyte respectively during differentiation induction and then the cells are collected to be analyzed the content of triglyceride after 8 days of differentiation. TG synthesis is an indicator for the differentiation late phase of the fat cells, thus the TG content in cells are usually used to determine the differentiation rate. Referring to FIGS. 6A and 6B, the results demonstrate that all dosage groups can inhibit the differentiation of 3T3-L1 preadipocyte significantly, and the TG content is decreased by 50% approximately.

Referring to FIG. 6C, 50, 75 and 100 μg/mL of ethanol extracts of red mold rice have significant inhibition effects on 3T3-L1 preadipocyte, and the inhibition rate are 26%, 49.3% and 53% respectively; referring to FIG. 6D, 50 μg/mL of ethanol extracts of red mold dioscorea can inhibit the differentiation of cells by 54.9%.

Referring to FIG. 6E, 0.125 and 0.25 mg/mL of ankaflavin, the secondary metabolite of Monascus, can inhibit the differentiation of 3T3-L1 preadipocyte significantly, and the inhibition rates are 41.2% and 29.9 respectively. Referring to FIG. 6F, 0.125 mg/mL of monascin, the secondary metabolite of Monascus, can inhibit the differentiation of 3T3-L1 preadipocyte by the rate of 31.2%.

[Animal Experiments]

### 1. Body Weight and Body Fat

Rats are randomly divided into to 9 groups, each include 8 rats, on the principles that the initial average weights of rats are unanimous. Rats are fed with high-fat diet and Monascus fermented product at the same time in experiments and then sacrificed for every analyses after 6 weeks of feeding. In this research, the examination groups comprise: C, the group of rats fed with normal diet; HF, the group of rats fed with high-fat diet; L, the group of rats fed with Monacolin K (lovastatin); R, the group of rats fed with un fermented rice; D, the group of rats fed with unfermented dioscorea; RL, the group of rats fed with low dosage of red mold rice; RH, the group of rats fed with high dosage of red mold rice; DL, the group of rats fed with low dosage of red mold dioscorea; and DH, the group of rats fed with high dosage of red mold dioscorea.

Referring to Table 1, the results demonstrate that the body weight in HF group is higher than that in C group, and the body weights in groups of rats fed with Monascus fermented products (RL, RH, DL, and DH) are decreased significantly. In the amount of body weight variation, the body weights of RL group, RH group and DH group are significantly decreased by 21.5%, 30.5% and 20.0%, the results demonstrate that red mold rice and red mold dioscorea have effects on the body weight reduction.

TABLE 1

| | Initial body | Final body | Increment of |
|---|---|---|---|
| | weight (g) | weight (g) | body weight (g) |
| C | 324.5 | 439.8 | 115.3 |
| HF | 333.8 | 504.8 | 171.0 |
| L | 331.3 | 472.4 | 141.1 |
| R | 331.0 | 487.5 | 156.5 |
| D | 330.8 | 491.0 | 160.3 |
| RL | 325.0 | 459.3 | 134.3 |
| RH | 320.3 | 439.1 | 118.9 |
| DL | 318.8 | 468.0 | 149.3 |
| DH | 324.5 | 461.3 | 136.8 |

### 2. Analyzing Lipolysis Activity of Adipose Tissue

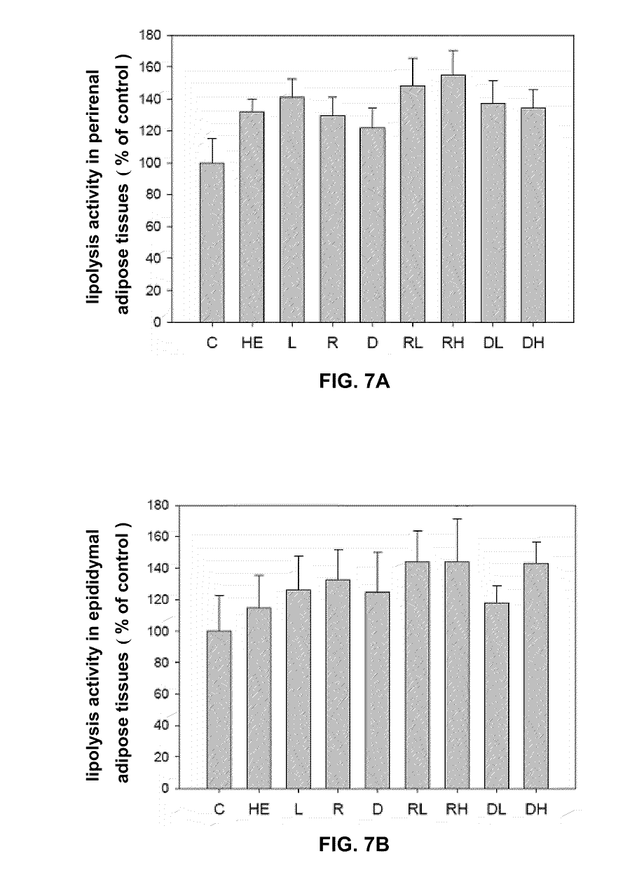

Referring to FIGS. 7A and 7B, there are shown that Monascus fermented products affecting lipolysis activity respectively in perirenal and epididymal adipose tissues of male Wister rats fed with high-fat diet. These results demonstrate that lipolysis activity in perirenal and epididymal adipose tissues can be enhanced significantly by feeding the rats with red mold rice (RL and RH). In perirenal adipose tissue, lipolysis activity in RL and RH groups are increased by 12.3% and 17.3% respectively; in epididymal adipose tissue, lipolysis activity in RL and RH groups are increased by 29.0% and 30.0% respectively. Lipolysis activity in epididymal adipose tissue of rats fed with high dosage of red mold dioscorea (DH) is increased significantly by 29.0%. Additionally, lipolysis activity in normal diet group (C) is lower than that in high-fat diet group (HF) because that lipolysis activity is in direct ratio with the amount of body fat under normal circumstance. The more body fat, the more vigorous the metabolism activity in tissue is, and this situation can satisfy the balance of metabolism.

From the above cell and animal experiments, the results reveal that the Monascus fermented products of the present invention can improve the body fat accumulation caused by high-fat diet and stimulate the lipolysis activity in cells. Thus, Monascus fermented products have potential to be antiobesity functional foods.

The foregoing embodiments are provided to illustrate and disclose the technical principles and features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. A method for manufacturing the composition of Monascus fermented product with a function that reduces body fatness formation comprising the steps of:
(1) drying a Monascus substrate;
(2) grinding the dried Monascus substrate to powder;
(3) extracting the powdered Monascus substrate with water under a first specific temperature for a specific time period;
(4) filtering the extracted product through a filtration membrane with a specific pore diameter;
(5) freeze-drying the filtrate; and
(6) dissolving the dried product to a specific concentration with a specific solvent and preserving the solution under a second specific temperature.

2. The method for manufacturing the composition of Monascus fermented product with a function that reduces body fatness formation according to claim 1, wherein the Monascus substrate in steps (1), (2) and (3) is selected from the group consisted of: red mold rice and red mold dioscorea.

3. The method for manufacturing the composition of Monascus fermented product with a function that reduces body fatness formation according to claim 1, wherein the Monascus substrate at least comprises monascin and ankaflavin as active ingredients.

4. The method for manufacturing the composition of Monascus fermented product with a function that reduces body fatness formation according to claim 3, wherein 1 g of the Monascus substrate has to contain 1˜30 mg of the monascin.

5. The method for manufacturing the composition of Monascus fermented product with a function that reduces body fatness formation according to claim 3, wherein 1 g of the Monascus substrate has to contain 0.5˜25 mg of the ankaflavin.

6. The method for manufacturing the composition of Monascus fermented product with a function that reduces body fatness formation according to claim 1, wherein the Monascus substrate at least comprises Monacolin K as an active ingredient, and 1 g of the Monascus substrate has to contain 2˜15 mg of the Monacolin K.

7. The method for manufacturing the composition of Monascus fermented product with a function that reduces body fatness formation according to claim 1, wherein the first specific temperature in step (3) is 25˜65° C., and the specific time period is 24 hours.

8. The method for manufacturing the composition of Monascus fermented product with a function that reduces body fatness formation according to claim 1, wherein the specific pore diameter in step (4) is 0.22˜0.45 μm.

9. The method for manufacturing the composition of Monascus fermented product with a function that reduces body fatness formation according to claim 1, wherein the specific solvent in step (6) is phosphate buffer saline (PBS), the specific concentration is 50˜200 μg/mL, and the second specific temperature is −20˜7° C.

10. A method for manufacturing the composition of Monascus fermented product with a function that reduces body fatness formation comprising the steps of:
(1) drying a Monascus substrate;
(2) grinding the dried Monascus substrate to powder;
(3) extracting the powdered Monascus substrate with water under a first specific temperature for a first specific time period;
(4) filtering the extracted product through a filtration membrane with a first specific pore diameter;
(5) dissolving the non-filtrate with a first specific concentration of ethanol and extracting the solution under a second specific temperature for a second specific time period;
(6) filtering the extracted product through a filtration membrane with a second specific pore diameter;
(7) placing the filtrate in a ventilated space to evaporate the ethanol naturally; and
(8) dissolving the dried product to a second specific concentration with ethanol again and preserving the solution under a third specific temperature.

11. The method for manufacturing the composition of Monascus fermented product with a function that reduces body fatness formation according to claim 10, wherein the Monascus substrate in steps (1), (2) and (3) is selected from the group consisted of: red mold rice and red mold dioscorea.

12. The method for manufacturing the composition of Monascus fermented product with a function that reduces body fatness formation according to claim 10, wherein the Monascus substrate at least comprises monascin and ankaflavin as active ingredients.

13. The method for manufacturing the composition of Monascus fermented product with a function that reduces body fatness formation according to claim 12, wherein 1 g of the Monascus substrate has to contain 1˜30 mg of the monascin.

14. The method for manufacturing the composition of Monascus fermented product with a function that reduces body fatness formation according to claim 12, wherein 1 g of the Monascus substrate has to contain 0.5˜25 mg of the ankaflavin.

15. The method for manufacturing the composition of Monascus fermented product with a function that reduces body fatness formation according to claim 10, wherein the Monascus substrate at least comprises Monacolin K as an active ingredient, and 1 g of the Monascus substrate has to contain 2˜15 mg of the Monacolin K.

16. The method for manufacturing the composition of Monascus fermented product with a function that reduces body fatness formation according to claim 10, wherein the first specific temperature in step (3) is 25˜65° C., and the first specific time period is 24 hours.

17. The method for manufacturing the composition of Monascus fermented product with a function that reduces body fatness formation according to claim 10, wherein the first specific pore diameter in step (4) is 0.22˜0.45 μm.

18. The method for manufacturing the composition of Monascus fermented product with a function that reduces body fatness formation according to claim 10, wherein the first specific concentration in step (5) is 50%˜95%, the second specific temperature is 25˜65° C., and the second specific time period is 24 hours.

19. The method for manufacturing the composition of Monascus fermented product with a function that reduces body fatness formation according to claim 10, wherein the second specific pore diameter in step (6) is 0.22˜0.45 μm.

20. The method for manufacturing the composition of Monascus fermented product with a function that reduces body fatness formation according to claim 10, wherein the second specific concentration in step (8) is 50˜200 μg/mL, and the third specific temperature is −20˜7° C.
